(19) United States
(12) Patent Application Publication
(10) Pub. No.: US 2025/0245252 A1
(43) Pub. Date: Jul. 31, 2025

(54) INTELLIGENT SOFTWARE DEVELOPMENT WORK DEDUPLICATION

(71) Applicant: Dell Products L.P., Round Rock, TX (US)

(72) Inventors: Omar Abdulaal, New Cairo (EG); Sarah Tarek Ebeid AbdelAzeem, Giza (EG); Ahmed Elsayed Elshafey, New Cairo (EG); Ahmed Mohamed Hamed Zahran, New Cairo (EG); Mahi Ismail, New Cairo (EG); Rana Afifi, New Cairo (EG); Shary Beshara, Cairo (EG); Yasmin Mansy, Cairo (EG)

(21) Appl. No.: 18/427,606

(22) Filed: Jan. 30, 2024

(51) Int. Cl. G06F 16/33; G06F 8/40; G06F 40/289

(52) U.S. Cl. CPC G06F 16/3344; G06F 8/40; G06F 40/289

(57) ABSTRACT

One example method includes accessing natural language user stories that have been generated by a user and that describe at least functionality for code located in codebase repositories. Natural language outputs are extracted from the natural language user stories that are related to the functionality. A search is performed of natural language summarizations that have been generated for the code located in the one or more code repositories. In response to finding natural language summarizations that match the extracted natural language outputs, providing the code in the codebase repositories whose natural language summarizations match the extracted natural language outputs to the user.

### FIELD OF THE INVENTION

Embodiments of the present invention generally relate to code searching. More particularly, at least some embodiments of the invention relate to systems, hardware, software, computer-readable media, and methods for finding specific code chunks in a codebase based on functionality extracted from user natural language stories.

### BACKGROUND

In large organizations there are usually many teams working to develop different solutions. These teams often work using different project management and source code solutions. Most of the time, there is no constant line of communication between these teams that allow these teams to know what each team is working on. This often results in the scenario where different teams are working on the same problem and developing the same code, which means that the organization can be unintentionally expending duplicated and wasted efforts. This results in inefficiency and unneeded repeated work.

To reduce such inefficiencies and unneeded repeated work, code developers may want to find out before working on new code for a particular solution whether another team has already developed code that will implement the particular solution. Knowing beforehand whether code exists that will implement the particular solution allows the developers to decide if they should start working on new code if existing code does not exist, use the existing code themselves, or just take a small component of the existing code to use in their own solution.

Currently, however, there is no easy or simple way to know if the other team has already developed the code that will implement the particular solution. The developers are often left to relying on their own contact network to give them leads on what types of code have already been developed. However, it is highly unlikely that any developer will have a contact network that will cover the entire large organization.

In addition to not having a large enough contact network, the developer will also generally run into the following problems when attempting to code search across the large organization. (1) The developer can only search for code snippets to find matching code. So, the developer would need to know some pieces of the implementation beforehand to find existing code. (2) It is difficult to search codebase across an organization where multiple version control systems (VCS) hosts are in use. The developer would need to search each VCS independently, which, even if possible, would be prohibitively time consuming. (3) The developer would have an inability to map existing code to its intended functionality as described by user stories.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of a pipeline for implementing the embodiments disclosed herein;

FIG. 2 discloses aspects of user story functionality extractor module according to the embodiments disclosed herein;

FIGS. 3A-3C disclose aspects of an analyzer and summarization module according to the embodiments disclosed herein;

FIGS. 4A-4B disclose aspects of a code finder module according to the embodiments disclosed herein;

FIG. 5 discloses a method according to an embodiment; and

FIG. 6 discloses an example computing entity configured to perform any of the disclosed methods, processes, and operations.

### DETAILED DESCRIPTION OF SOME EXAMPLE EMBODIMENTS

Embodiments of the present invention generally relate to code searching. More particularly, at least some embodiments of the invention relate to systems, hardware, software, computer-readable media, and methods for finding specific code chunks in a codebase based on functionality extracted from user natural language stories.

One example method includes accessing natural language user stories that have been generated by a user and that describe at least functionality for code located in codebase repositories. Natural language outputs are extracted from the natural language user stories that are related to the functionality. A search is performed of natural language summarizations that have been generated for the code located in the one or more code repositories. In response to finding natural language summarizations that match the extracted natural language outputs, providing the code in the codebase repositories whose natural language summarizations match the extracted natural language outputs to the user.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Context for Some Example Embodiments

Large organizations are typically working on many software solutions, products and services including many features at the same point in time. These projects could have feature overlaps; similar components or functionality implemented separately in each. Sometimes this means multiple teams are developing the same feature, library, microservice, or function at the same time without realizing, or developing even something that has been developed previously in a different project. The current invention makes it possible to reduce this software development duplication.

The current way large organizations address this problem is to have a common source code system or use the same project tracking solution (such as Jira) to manage their features and product/solution requirements and make them all available for search within the same system. However, due to the size of large organizations, it is impossible to have a unified solution for version control systems (VCS) or project management throughout the entire organization. Different sub-organizations use their own preferred solutions. Communication challenges and organizational silos make it difficult to leverage or gain visibility on existing code/implementation or features in other teams and organizations.

The embodiments of the current invention address this by analyzing code and user stories. User stories are small and detailed descriptions of software features describing the value for the end-user. Stories represent the smaller working units and are typically used to achieve alignment between product managers and software developers for the requirements.

The embodiments of the current invention utilize natural language processing (NLP) solutions to mitigate the human intervention needed to find existing code across the organization. The embodiments of the current invention provide an intelligent finding and visibility into existing code that has been implemented and can be used in either the VCS or project/backlog management system in the large organization.

The embodiments of the current invention are architected in such a way that eliminates the need for a singular organization-wide VCS or project management solution, thus saving time and resources for the organization. The embodiments of the current invention can be easily implemented as a plug into different VCS and project management systems, and can index existing code into a common searchable database. The embodiments of the current invention identify if any code exists in the organizations various VCS hosts accomplishes a similar functionality to a given user story written in natural language.

### B. Aspects of Some Example Embodiments

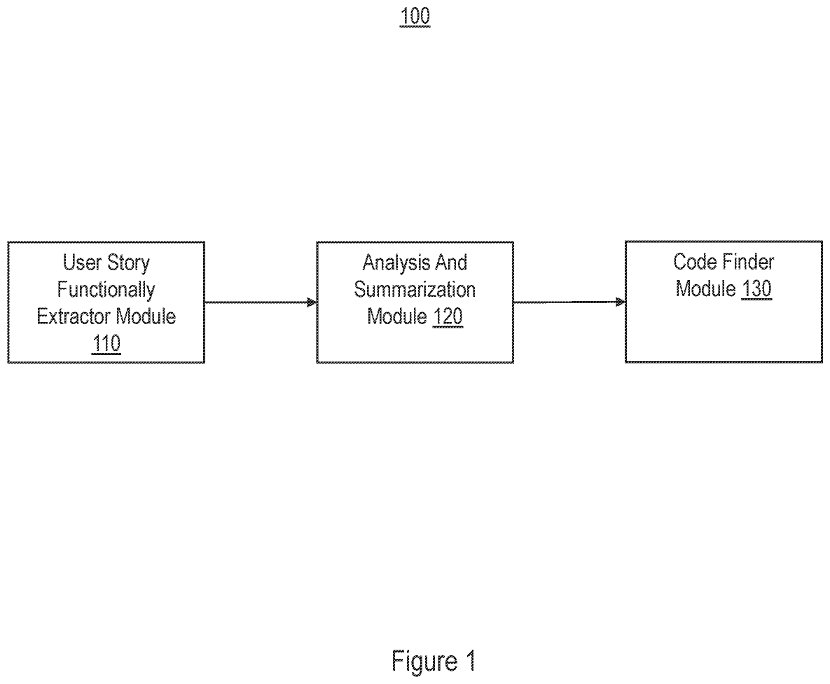

FIG. 1 illustrates an embodiment of a pipeline 100 for implementing the current invention. The pipeline 100 includes various modules or functional blocks that may implement the various embodiments disclosed herein as will be explained. The various modules or functional blocks of the pipeline 100 (and any other modules or functional blocks described herein) may be implemented on a local computing system or may be implemented on a distributed computing system that includes elements resident in the cloud or that implement aspects of cloud computing. The various modules or functional blocks of the pipeline 100 may be implemented as software, hardware, or a combination of software and hardware. The pipeline 100 may include more or less than the modules illustrated in FIG. 1 and some of the modules may be combined as circumstances warrant. Although not necessarily illustrated, the various modules of the pipeline 100 may access and/or utilize a processor and memory, such as processor 606 and memory 604 described in more detail to follow, as needed to perform their various functions. Accordingly, the exact structure of the pipeline 100 is not to be considered limiting to the embodiments disclosed herein.

As illustrated, the pipeline 100 includes three pipeline components. A first pipeline component of the pipeline 100 is a user story functionality extractor module 110. As will be described in more detail to follow, in operation the user story functionality extractor module 110 receives a natural language user story from a user that details at least the user's intent for a given piece of existing code and the desired functionality of the piece of existing code. The user story functionality extractor module 110 then extracts keywords that are related to or otherwise specify the desired intent and functionality.

As further illustrated, a second pipeline component of the pipeline 100 is an analysis and summarization module 120. As will be described in more detail to follow, in operation the analysis and summarization module 120 analyzes code repositories across the organization and generates natural language summarizations of the code. The summarized code is then indexed with at least the location of the code repository that stores the summarized code. In some embodiments, the analysis and summarization module 120 splits the code in the code repositories into different code modules or splits the code into smaller code chunks based on functionality as part of generating the natural language summarizations.

As also illustrated, a third pipeline component of the pipeline 100 is a code finder module 130. As will be described in more detail to follow, in operation the code finder module 130 performs a search of the user story intent and functionality across the indexed code. Any index code that is found to be similar to the user story intent and functionality is provided to the user.

B.1 Aspects of Functionality Detection from User Stories

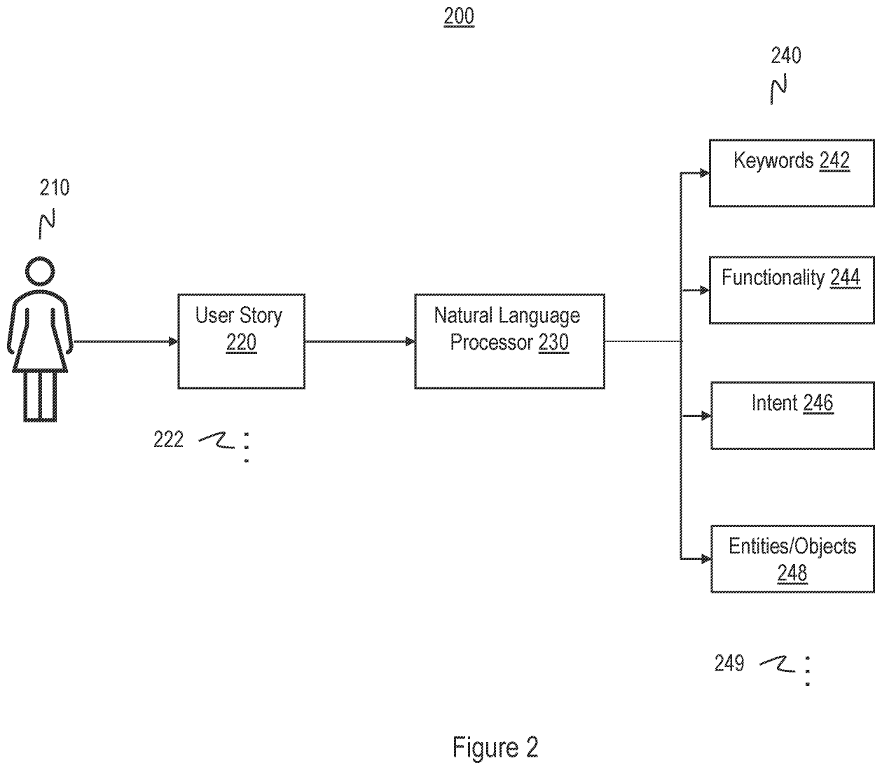

FIG. 2 illustrates an embodiment of a user story functionality extractor module 200 that corresponds to the user story functionality extractor module 110. As illustrated, a user 210 generates a user story 220 in the developer's natural language. The natural language describes the functionality and intent of the code that the user 210 requires for his or her code. As previously described, user stories are small and detailed descriptions of software features describing the value for the user 210. The ellipses 222 illustrate that the user 210 may generate any number of user stories given the needs of the user 210 for different kinds of code.

The user stories 220 and 222 are received by a natural language processor 230 that is implemented by one or more machine learning natural language processing (NLP) models. For example, in one embodiment, the natural language processor 230 may be one or more large language models (LLMs) such as T5 based Flan-T5 or Chat GPT. In other embodiments, the natural language processor 230 may be one or more intent extractor models such as Spacy that works in conjunction with a code summarization. In still other embodiments, the natural language processor 230 may be one or more NLP models that extract named entities and/or objects. In still further embodiments, the natural language processor 230 may be any combination of the NLP models discussed or of any other reasonable NLP model. Thus, depending on the desired outcome of the user story analysis and how the user 210 wants to search against a codebase, different NLP models or combinations of NLP models may be used. Accordingly, the embodiments and claims disclosed herein are not limited to any particular number or type of NLP model used to implement the natural language processor 230.

In operation, the natural language processor 230 extracts various natural language outputs 240 from the user stories 220 and 222. For example, the natural language outputs 240 may include one or more of keywords 242, functionality 244, code intent 246 that describes the intent of the code or in other words what action the code in intended to perform, and entities and/or objects 248 that are related to the required code functionality that the user 210 desires to find when the codebase is searched. The ellipses 249 illustrate that the natural language processor 230 may extract any number of additional outputs from the user stories 220 and 222 that are related to the required code functionality that the user 210 desires to find when the codebase is searched.

A specific example will now be given. Suppose that the user 210 generated the following natural language story 220: “As a user I want to login to the website sot that I can access my account successfully.” This natural language story 220 would be provided to the natural language processor 230. In this example, the natural language processor 230 would extract the following code components and functionality as examples of the natural language outputs 240 from the story 210: (1) a login page, (2) an authentication system, (3) a user account system, (4) a session management system, and (5) password encryption.

### B.2 Aspects of Codebase Analysis and Summarization

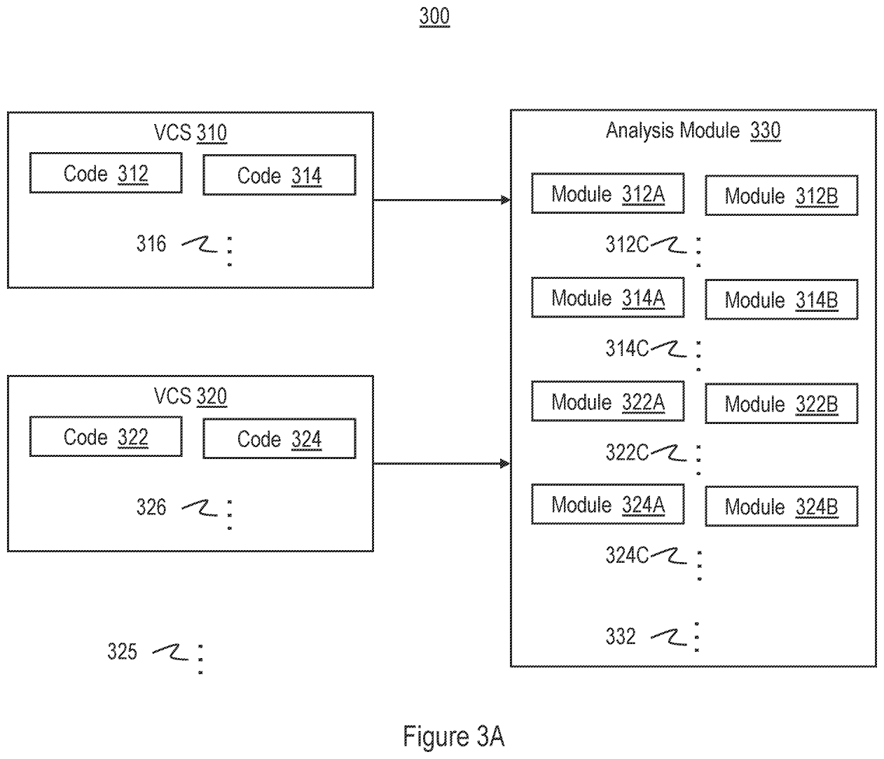

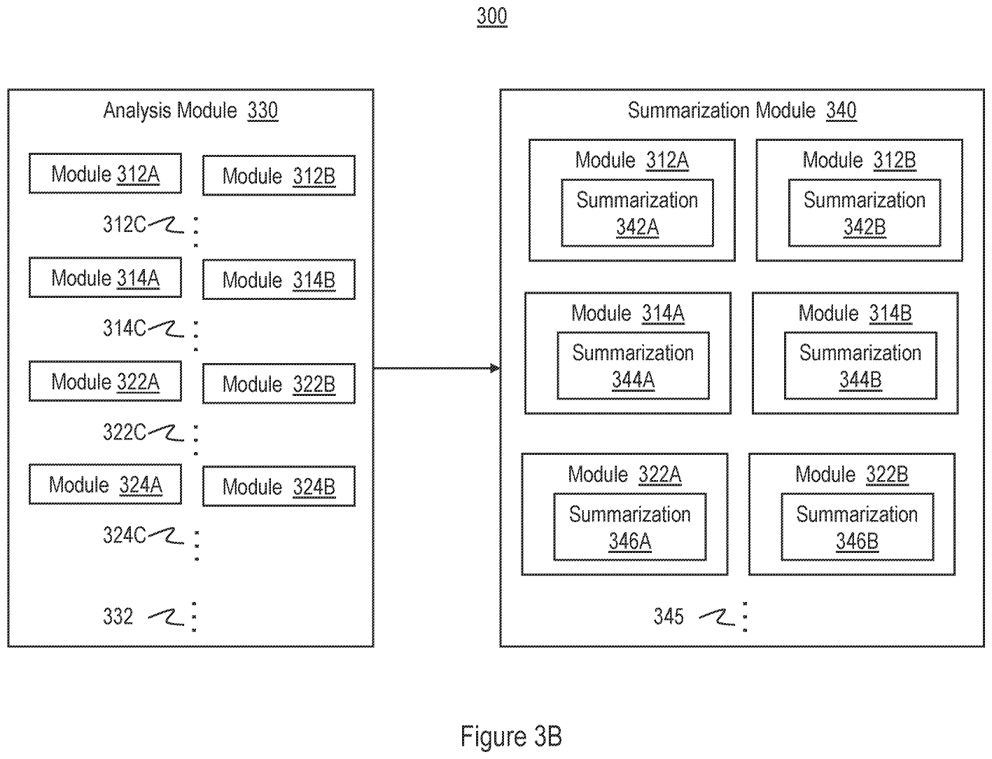

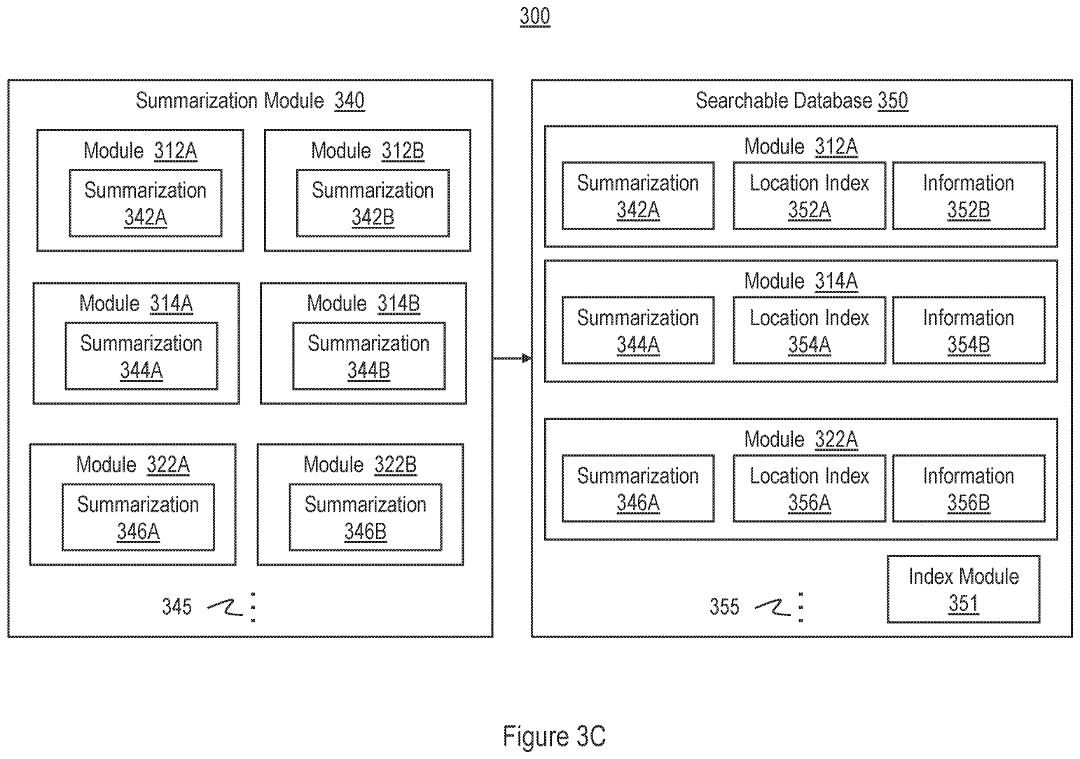

FIGS. 3A-3C illustrate an embodiment of an analyzer and summarization module 300 that corresponds to the analysis and summarization module 120. As illustrated in FIG. 3A, an organization may have various codebase repositories that is included in a VCS 310, a VCS 320, and any number of additional codebase repositories as illustrated by the ellipses 325. The VCS 310 includes code 312, code 314 and any amount of additional code as illustrated by the ellipses 316. The VCS 320 includes code 322, code 324 and any amount of additional code as illustrated by the ellipses 326.

The analysis and summarization module 120 includes an analysis module 330. In one embodiment, the analysis module 330 is implemented by any reasonable parser or static analyzer known to those of sill in the art. In operation, the analysis module 330 analyzes the code 312-316 in the VCS 310, the code 322-326 in the VCS 320, and any code in the additional codebase repositories 325 to split or chunk the code into different smaller modules. In some embodiments, the modules may be one file of the code according to the programming language of the codebase. In other embodiments, the modules may be based on different functionality of the codebase.

For example, the analysis module 330 splits or chunks the code 312 into code module 312A, code module 312B, and any number of additional code modules as illustrated by the ellipses 312C. The analysis module 330 splits or chunks the code 314 into code module 314A, code module 314B, and any number of additional code modules as illustrated by the ellipses 314C. The analysis module 330 splits or chunks the code 322 into code module 322A, code module 322B, and any number of additional code modules as illustrated by the ellipses 322C. The analysis module 330 splits or chunks the code 324 into code module 324A, code module 324B, and any number of additional code modules as illustrated by the ellipses 324C. The ellipses 332 illustrate that the analysis module 330 is able split or chunk the code from the additional codebase repositories 325 into code modules.

As shown in FIG. 3B, the analysis and summarization module 120 includes a summarization module 340. In one embodiment, the summarization module 340 is implemented by one or more machine learning transformer models such as, but not limited to, Chat GPT, Code T5, and CodeXGLUE. In operation, the summarization module 340 translates the functions and modules of the code modules and generates a searchable natural language summarization that can be used in a search as will be described in more detail to follow.

For example, the summarization module 340 generates a natural language summarization 342A for the code module 312A, a natural language summarization 342B for the code module 312B, a natural language summarization 344A for the code module 314A, a natural language summarization 344B for the code module 314B, a natural language summarization 346A for the code module 322A, and a natural language summarization 346B for the code module 322B. The ellipses 345 illustrate that the summarization module 340 also generates a natural language summarization for the code modules 312C, 314C, 322C, 324C, and the additional code modules 332.

As shown in FIG. 3C, the analysis and summarization module 120 includes a searchable database 350, which may be any reasonable database. As illustrated, the searchable database 350 includes an index module 351, which in operation generates a location index for each of the code modules. In some embodiments, the index module 351 may be implemented as a search and index model such as Elasticsearch.

For example, index module 351 generates a location index 352A for the code module 312A, a location index module 354A for the code module 314A, and a location index 356A for the code module 322A. Although not shown for ease of illustration, the index module 351 also generates a location index for the other code modules previously described herein as illustrated by ellipses 355. In one embodiment, the location indexes are a link or pointer to the location of each code module in one or more of the VCS 310, VCS 320, or one of the additional codebase repositories 325. In other embodiments, the location index includes information that specifies how the user 210 may gain access to VCS 310, VCS 320, or one of the additional codebase repositories 325 that he or she is not authorized to access. In still other embodiments, the searchable database 350 may store the actual code modules. Storing the actual code modules may be done as a way to ensure that the user 210 has access to the code modules without having to be given authorization to access VCS 310, VCS 320, or one of the additional codebase repositories 325. In such embodiments, the location index may include the location of the code modules in the searchable database 350.

In some embodiments, the index module 351 or some other module associated with the searchable database 350 generates additional information about each of the code modules. In one embodiment, the additional information may include contact information for the author of each code module or a link to where such information may be found in the codebase repositories. Such contact information allows the user 210 to discuss with the author of the code module will provide any desired functionality, thus saving on time and resources. The other information may also or alternatively include any further information needed to ensure that the user 210 is able to locate a needed code module when a search is performed as will be explained in more detail to follow.

For example, the index module 351 generates information 352B for the code module 312A, generates information 354B for the code module 314A, and generates information 356B for the code module 322A. Although not shown for ease of illustration, the index module 351 also generates the additional information for the other code modules previously described herein as illustrated by ellipses 355.

Thus, the searchable database 350 stores for each code module the natural language summarization, the location index, and in some embodiments the additional information. As discussed previously, in some embodiments, the searchable database 350 may store the actual code modules as well.

### B.3 Aspects of Matching Code Functionality to User Stories

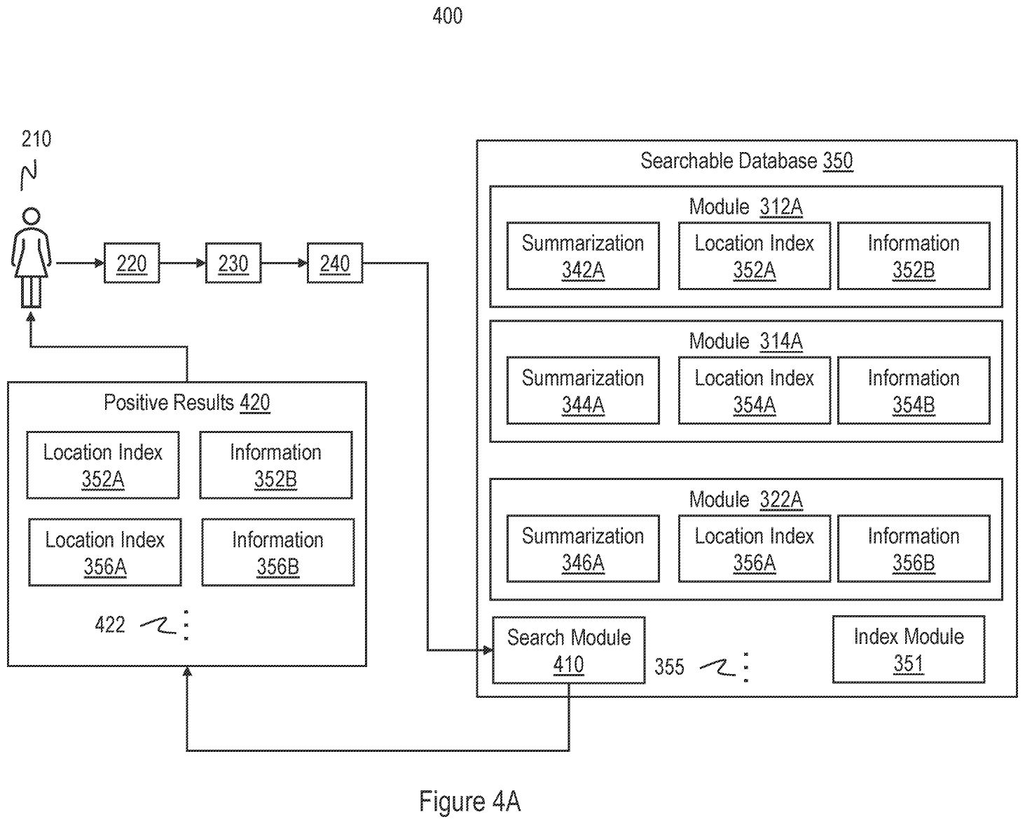

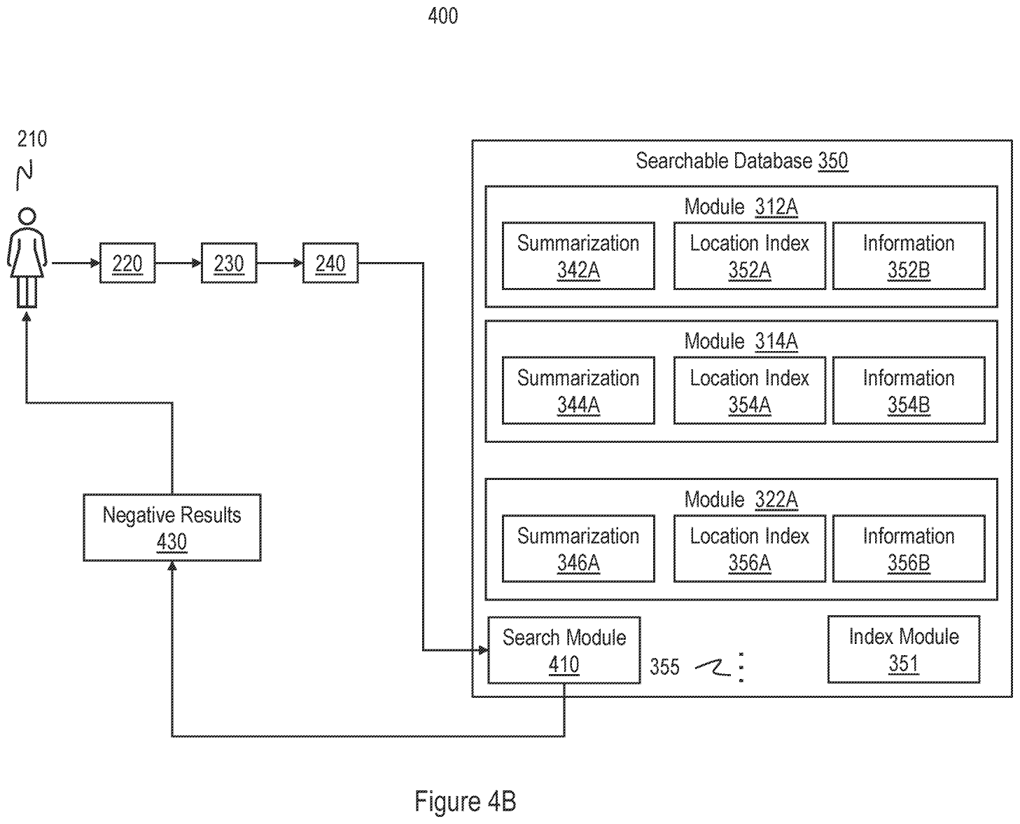

FIGS. 4A-4B illustrate an embodiment of code finder module 400 that corresponds to the code finder module 130. As illustrated in FIG. 4A, the code finder module 400 includes a search module 410. In FIG. 4A, the search module 410 is shown as being part of the searchable database 350. It will be appreciated that this is for ease of illustration only and that the search module 410 need not be part of the searchable database 350.

In operation, the search module 410 receives or otherwise accesses the natural language outputs 240 including the keywords 242, functionality 244, code intent 246, and entities and/or objects 248 that have been extracted from the user story 220 by the natural language processor 230 in the manner previously described. The search module 410 then performs a search of the natural language outputs 240 against the code modules included in the searchable database 350. In particular, the search module 410 compares the indexed natural language summarizations with the natural language outputs 240 that has been extracted from the user story 220.

As shown in FIG. 4A, when code modules having natural language summarizations that match the natural language outputs 240, this positive result is returned to the user 210. For example, suppose in one embodiment that the natural language summarizations 342A of the code module 312A and the natural language summarizations 346A of the code module 322A matched or at least partially matched the natural language outputs 240. In such embodiment, the positive results 420 that include the location index 352A of the code module 312A and location index 356A of the code module 322A would be returned to the user 210. As discussed previously, the location indexes can be a link to the location of the code modules in one or more of the VCS 310, VCS 320, or one of the additional codebase repositories 325. In other embodiments, the location indexes may be the actual code modules or the location of the code modules in the searchable database 350.

In those embodiments that include the additional information, the additional information 352B of the code module 312A and the additional information 356B of the code module 322A may also be provided as part of the positive results 420. As discussed previously, the additional information may include contact information or a link to the contact information for the author of the code modules, information needed to access the code modules in one or more of the VCS 310, VCS 320, or one of the additional codebase repositories 325, and/or any other information needed by the user 210. The ellipses 422 illustrate that the positive results may include any number of additional location indexes and potentially additional information about any number of additional code modules who natural summarizations are found to match the natural language outputs 240.

Upon receipt of the positive results 420, the user 210 is able to verify if the code modules 312A and 322A (and potentially additional code modules indicated by the ellipses 422) includes the functionality the user 210 desired. If so, the user 210 is able to implement the code modules into the solution he or she is working on. The user 210 is thus able to save on the time and computing system resources that otherwise would have been needed to develop the code modules 312A and 322A independently. In particular, the user 210 is able to find and then access the code modules 312A and 322A without any knowledge of: (1) the underlying programming language of the code modules, (2) any implementation details of the code modules, or (3) the need to have snippet of the code modules.

However, there may be instances where no code modules having natural language summarizations that match the natural language outputs 240 are found by the search module 410. In one embodiment, no action is taken by the search module 410 or other components of the system and the user 210 infers no matches by the lack of any action. In other embodiments, however, as shown in FIG. 4B the search module 410 or some other component of the system returns negative results 430 to the user 210. The negative results 430 inform the user 210 that no matches were found. The user 210 knows that he or she will have to develop the code themselves as needed.

In some embodiments, the analysis and summarization module 120 need not include the analysis module 330. In such embodiments, the summarization module 340 is able to generate the natural language summarizations for the code 312-316 and the code 322-326 without the need for splitting the code into modules. Thus, in such embodiments, the search module 410 would compare the natural language summarizations for the code 312-316 and the code 322-326 with the natural language outputs 240 extracted from the user story 220 and would provide the code 312-316 and the code 322-326 whose natural language summarizations matched the natural language outputs 240 in the manner previously described. The use of the analysis module 330 to split the code into modules can be advantageous, however, as it make the generation of the natural language summarizations more manageable by the computing system.

### C. Example Methods

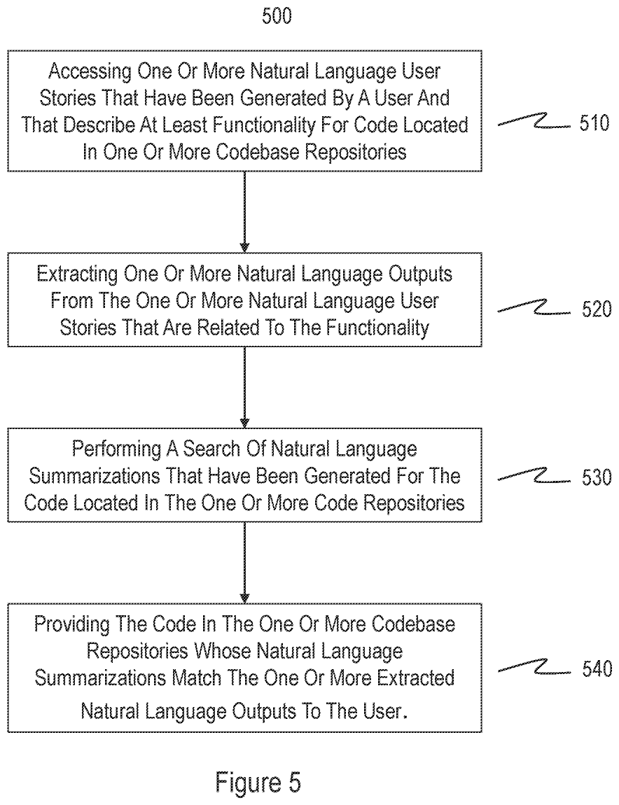

It is noted with respect to the disclosed methods, including the example method 500 of FIG. 5, that any operations of any of these methods, may be performed in response to, as a result of, and/or, based upon, the performance of any preceding operations. Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 5, an example method 500 is disclosed. The method 500 will be described in relation to one or more of the figures previously described, although the method 500 is not limited to any particular embodiment.

The method 500 includes accessing one or more natural language user stories that have been generated by a user and that describe at least functionality for code located in one or more codebase repositories (510). For example, as previously described the user 210 generates the user stories 220 and 222 that use natural language to describe at least the functionality of existing code located in the VCS 310, the VCS 320, or the additional codebase repositories 325 that the user 210 desires to find and use. The user stories 220 and 222 are accessed by the natural language processor 230.

The method 500 includes extracting one or more natural language outputs from the one or more natural language user stories that are related to the functionality (520). For example, as previously described the natural language processor 230 extracts the natural language outputs 240 includes keywords 242, functionality 244, code intent 246, and/or entities and objects 248.

The method 500 includes performing a search of natural language summarizations that have been generated for the code located in the one or more code repositories (530). For example, as previously described the summarization module 340 generates the natural language summarizations 342A, 342B, 344A,344B, 346A, and 346B for the code 231-316 and 322-326. In some embodiments, the analysis module 330 splits the code 231-316 and 322-326 into code modules 312A-312C, 314A-314C, 322A-322C, and 324A-324C and the natural language summarizations are generated for the code modules.

The method 500 includes in response to finding one or more natural language summarizations that match the one or more extracted natural language outputs, providing the code in the one or more codebase repositories whose natural language summarizations match the one or more extracted natural language outputs to the user (540).). For example, as previously described the positive results 420 are provided to the user 210 that include the location index of the code. In some embodiments, the location index is a link to the location of the code in one or more of the VCS 310, the VCS 320, or the additional codebase repositories 325. In other embodiments, the location index is the actual code or the location of the code in the searchable database 350.

### D. Further Example Embodiments

Following are some further example embodiments of the invention. These are presented only by way of example and are not intended to limit the scope of the invention in any way.

Embodiment 1. A method, comprising: accessing one or more natural language user stories that have been generated by a user and that describe at least functionality for code located in one or more codebase repositories; extracting one or more natural language outputs from the one or more natural language user stories that are related to the functionality; performing a search of natural language summarizations that have been generated for the code located in the one or more code repositories; and in response to finding one or more natural language summarizations that match the one or more extracted natural language outputs, providing the code in the one or more codebase repositories whose natural language summarizations match the one or more extracted natural language outputs to the user.

Embodiment 2. The method as recited in embodiment 1, further comprising: splitting the code in the one or more codebase repositories into a plurality of code modules; and generating the natural language summarizations for each of the plurality of modules.

Embodiment 3. The method as recited in any of embodiments 1-2, wherein the code in the one or more codebase repositories is split into the plurality of modules based on functionality.

Embodiment 4. The method as recited in any of embodiments 1-3, wherein providing the code in the one or more codebase repositories to the user comprises providing a link to the code in the one or more codebase repositories.

Embodiment 5. The method as recited in any of embodiments 1-4, wherein providing the code in the one or more codebase repositories to the user comprises providing the actual code located in one or more codebase repositories to the user.

Embodiment 6. The method as recited in any of embodiments 1-5, further comprising: providing additional information to the user when providing the code located in one or more codebase repositories to the user, the additional information including one or more of information specifying how the user is to be given access to the code and contact information for the author of the code.

Embodiment 7. The method as recited in any of embodiments 1-6, wherein natural language outputs include keywords related to the functionality, an intent of the code located in one or more codebase repositories, and entities and objects in the code located in one or more codebase repositories.

Embodiment 8. The method as recited in any of embodiments 1-7, wherein the one or more natural language outputs are extracted from the one or more user stories using one or more machine learning natural language processing models.

Embodiment 9. The method as recited in any of embodiments 1-8, wherein the one or more natural language summarizations are generated using one or more machine learning transformer models.

Embodiment 10. The method as recited in any of embodiments 1-9, further comprising: in response to not finding one or more natural language summarizations that match the one or more extracted keywords: providing notification to the user; or taking no action.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### E. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that are executed on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to conduct executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

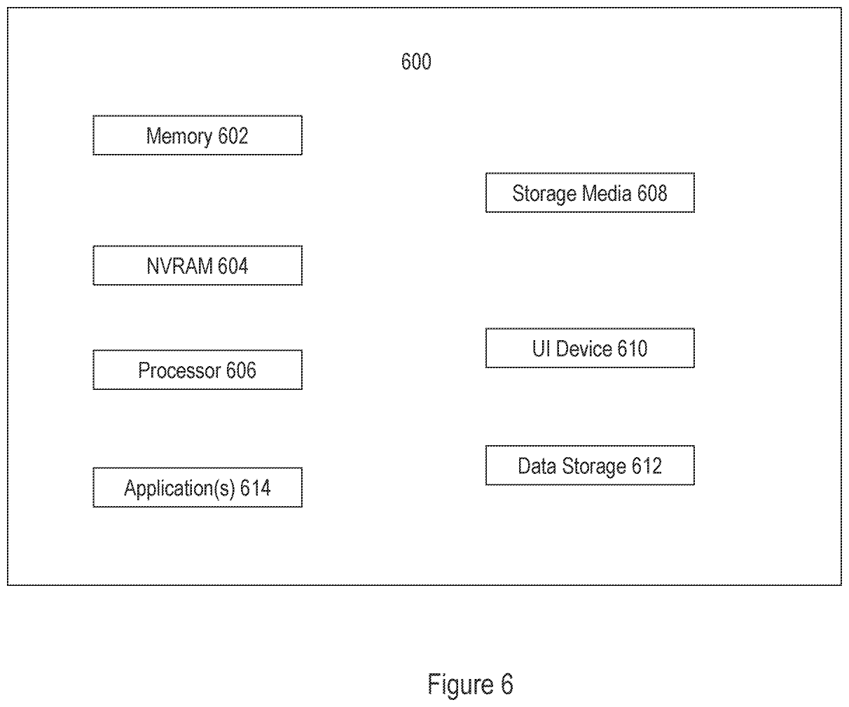

With reference briefly now to FIG. 6, any one or more of the entities disclosed, or implied, by FIGS. 1-5, and/or elsewhere herein, may take the form of, or include, or be implemented on, or hosted by, a physical computing device, one example of which is denoted at 600. As well, where any of the aforementioned elements comprise or consist of a virtual machine (VM), that VM may constitute a virtualization of any combination of the physical components disclosed in FIG. 6.

In the example of FIG. 6, the physical computing device 600 includes a memory 602 which may include one, some, or all, of random access memory (RAM), non-volatile memory (NVM) 604 such as NVRAM for example, read-only memory (ROM), and persistent memory, one or more hardware processors 606, non-transitory storage media 608, UI device 610, and data storage 612. One or more of the memory components 602 of the physical computing device 600 may take the form of solid state device (SSD) storage. As well, one or more applications 614 may be provided that comprise instructions executable by one or more hardware processors 606 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
accessing one or more natural language user stories that have been generated by a user and that describe at least functionality for code located in one or more codebase repositories;
extracting one or more natural language outputs from the one or more natural language user stories that are related to the functionality;
performing a search of natural language summarizations that have been generated for the code located in the one or more code repositories; and
in response to finding one or more natural language summarizations that match the one or more extracted natural language outputs, providing the code in the one or more codebase repositories whose natural language summarizations match the one or more extracted natural language outputs to the user.

2. The method of claim 1, further comprising:
splitting the code in the one or more codebase repositories into a plurality of code modules; and
generating the natural language summarizations for each of the plurality of modules.

3. The method of claim 2, wherein the code in the one or more codebase repositories is split into the plurality of modules based on functionality.

4. The method of claim 1, wherein providing the code in the one or more codebase repositories to the user comprises providing a link to the code in the one or more codebase repositories.

5. The method of claim 1, wherein providing the code in the one or more codebase repositories to the user comprises providing actual code located in one or more codebase repositories to the user.

6. The method of claim 1, further comprising:
providing additional information to the user when providing the code located in one or more codebase repositories to the user, the additional information including one or more of information specifying how the user is to be given access to the code and contact information for an author of the code.

7. The method of claim 1, wherein natural language outputs include keywords related to the functionality, an intent of the code located in one or more codebase repositories, and entities and objects in the code located in one or more codebase repositories.

8. The method of claim 1, wherein the one or more natural language outputs are extracted from the one or more user stories using one or more machine learning natural language processing models.

9. The method of claim 1, wherein the one or more natural language summarizations are generated using one or more machine learning transformer models.

10. The method of claim 1, further comprising:
in response to not finding one or more natural language summarizations that match the one or more extracted natural language outputs:
providing notification to the user; or
taking no action.

11. A non-transitory storage medium having stored therein instructions that are executable by one or more hardware processors to perform operations comprising:
accessing one or more natural language user stories that have been generated by a user and that describe at least functionality for code located in one or more codebase repositories;
extracting one or more natural language outputs from the one or more natural language user stories that are related to the functionality;
performing a search of natural language summarizations that have been generated for the code located in the one or more code repositories; and
in response to finding one or more natural language summarizations that match the one or more extracted natural language outputs, providing the code in the one or more codebase repositories whose natural language summarizations match the one or more extracted natural language outputs to the user.

12. The non-transitory storage medium of claim 11, further comprising:
splitting the code in the one or more codebase repositories into a plurality of code modules; and
generating the natural language summarizations for each of the plurality of modules.

13. The non-transitory storage medium of claim 12, wherein the code in the one or more codebase repositories is split into the plurality of modules based on functionality.

14. The non-transitory storage medium of claim 11, wherein providing the code in the one or more codebase repositories to the user comprises providing a link to the code in the one or more codebase repositories.

15. The non-transitory storage medium of claim 11, wherein providing the code in the one or more codebase repositories to the user comprises providing actual code located in one or more codebase repositories to the user.

16. The non-transitory storage medium of claim 11, further comprising:
providing additional information to the user when providing the code located in one or more codebase repositories to the user, the additional information including one or more of information specifying how the user is to be given access to the code and contact information for an author of the code.

17. The non-transitory storage medium of claim 11, wherein natural language outputs include keywords related to the functionality, an intent of the code located in one or more codebase repositories, and entities and objects in the code located in one or more codebase repositories.

18. The non-transitory storage medium of claim 11, wherein the one or more natural language outputs are extracted from the one or more user stories using one or more machine learning natural language processing models.

19. The non-transitory storage medium of claim 11, wherein the one or more natural language summarizations are generated using one or more machine learning transformer models.

20. The non-transitory storage medium of claim 11, further comprising:
in response to not finding one or more natural language summarizations that match the one or more extracted natural language outputs:
providing notification to the user; or
taking no action.
